(19) United States
(12) Patent Application Publication
(10) Pub. No.: US 2018/0174328 A1
(43) Pub. Date: Jun. 21, 2018

(54) TURNING RADIUS-BASED CORNER DETECTION ALGORITHM

(71) Applicant: HUIZHOU UNIVERSITY, Huizhou, Guangdong (CN)

(72) Inventors: Changlin Wan, Huizhou, Guangdong (CN); Deming Xu, Huizhou, Guangdong (CN); Jianzhong Cao, Huizhou, Guangdong (CN); Xiaohui Wei, Huizhou, Guangdong (CN)

(21) Appl. No.: 15/553,697

(22) PCT Filed: May 19, 2016
(86) PCT No.: PCT/CN2016/082576

§ 371 Date: Aug. 25, 2017

(30) Foreign Application Priority Data
May 12, 2016 (CN) 2016103187080

(51) Int. Cl. G06T 7/90; G06T 7/13; G06T 5/20; G06T 5/00

(52) U.S. Cl. CPC G06T 7/90; G06T 5/002; G06T 5/20; G06T 7/13

(57) ABSTRACT

The invention relates to a turning radius-based corner detection algorithm, comprising: S1: removing noise by Gaussian filtering and computing a gradient value of each pixel of an original image; S2: locating a neighboring pixel with closest grayscale to the pixel within given neighborhoods therearound; S3: computing a turning radius between the pixel and the closest neighboring pixel thereof; S4: computing a turning radius threshold; S5: marking a pixel with the turning radius which is greater than the threshold and maximum in the given neighborhoods as a corner. By the solution, the present invention can locate corners in images accurately and restrain fake corners resulting from noises and textures, and also can simplify the computation of the threshold and raise the computation efficiency, whereby automatic detection is realized and effect of corner detection is improved. The invention is applicable to 3D reproduction, visual locating, measurement, etc.

### FIELD OF THE INVENTION

The invention relates to corner detection techniques in the field of automation, in particular, relates to a turning radius-based corner detection algorithm.

### BACKGROUND OF THE INVENTION

There is no specific mathematical definition of corners of two-dimensional (2D) images yet, but as widely accepted, in 2D images, corners are pixels where brightness varies dramatically or pixels where curvature is maximum on curved edges of images. Corners contains important features of images, and the information content thereof is significantly high and information redundancy can be decreased efficiently, so the computing speed of images can be enhanced effectively, analysis and process thereof can be facilitated and real-time process becomes possible. Corner detection plays an important role in computer vision fields such as 3D scene reconstruction, motion estimation, target tracing, target identification, image registration and matching, etc.

A number of corner detection algorithms develop with researches on corner detection techniques go deeper gradually. Substantially, these algorithms can be sorted into three types: template matching-based corner detection, edge feature-based corner detection and brightness variation-based corner detection, which are described in detail hereinafter:

Template Matching-Based Corner Detection

Template matching-based corner detection works in the following way: setting a template with corner features, matching correlation and similarity of all the regions of the same size with the template in the image to the template. Because the features of corners are numerous and properties thereof are unclear, it is difficult to design a plenty of templates to match all types of corners.

Edge Feature-Based Corner Detection

Harris algorithm is one typical edge feature-based corner detection algorithm, which is a signal curvature feature-based extraction algorithm raised by C. Harris and M. J. Stephens. In this algorithm inspired by autocorrelation function used in signal processing, first-order curvature of the autocorrelation function is got by computing the eigenvalue of the matrix related to the autocorrelation function. The pixel is recognized as a corner if its two eigenvalues and curvature value are all high.

Brightness Variation-Based Corner Detection

Brightness variation-based corner detection is featured by directly extracting corners in accordance with characters of themselves instead of relying on other local features of the targets, it has been proved that this kind of algorithm can be executed fast and its real-time property is good. Susan algorithm is a classic one of this type of algorithms. Susan algorithm is an image processing approach raised by Smith and Brady, and it is based on that the pixel region comprises several approximately round templates of elements. The value of the corner response function (CRF) for each pixel is computed on the basis of the grayscale within the region of the template. If the value is greater than a given threshold and the local maximum value, the pixel is recognized as a corner. The deficiency of SUSAN corner detection algorithm is that the constant threshold utilized thereof is not adaptive to common status and self-adapting threshold should be employed to improve this algorithm.

### SUMMARY OF THE INVENTION

The invention relates to a turning radius-based corner detection algorithm, taking the turning radius between pixels as detection features, and whereby the objective of high computing efficiency and anti-noise detection can be realized.

The following technical solution can be utilized to achieve the objective above:

The invention relates to a turning radius-based corner detection algorithm, comprising:

S1: removing noise by Gaussian filtering and computing a gradient value of each pixel of an original image;
S2: locating a neighboring pixel with closest grayscale to the pixel within given neighborhoods therearound;
S3: computing a turning radius between the pixel and the closest neighboring pixel thereof;
S4: computing a turning radius threshold; and
S5: marking a pixel with the turning radius which is greater than the threshold and maximum in the given neighborhoods as a corner.

Furthermore, the step S1 comprises:

Sa1: carrying out transverse and longitudinal Gaussian smoothing on the original image by using one-dimensional Gaussian operator and getting a smoothed image a; and
Sa2: carrying out transverse and longitudinal filtering on the smoothed image by using a partial derivative of two-dimensional Gaussian operator and getting a gradient of the image.

Furthermore, in the step S2, for any pixel in the image a, selecting a pixel whose grayscale is closest to the pixel from four neighboring pixels thereof as a closest neighboring pixel, wherein the pixel is named a first pixel (i, j) and the closest neighboring pixel is named a second pixel (r, c).

Furthermore, the step S3 also comprises:

Sc1: dividing the grayscale difference a (i, j)−a(r, c) between the first pixel (i, j) and the second pixel (r, c) by a coordinate distance between the first and second pixels and getting a turning velocity (v) therebetween:

$$v = \frac{a ( i , j ) - a ( r , c )}{\sqrt{{( i - r )}^{2} + {( j - c )}^{2}}} ;$$

Sc2: taking an angle between gradient vectors of the first pixel (i, j) and the second pixel (r,c) as a turning angel between the first and second pixels, whose sine (sin Q) is:

$$sin Q = \sqrt{\frac{1}{2 \times ( 1 - \frac{{d}_{x} ( i , j ) \times {d}_{x} ( r , c ) + {d}_{y } ( i , j ) \times {d}_{y} ( r , c )}{\sqrt{( {d}_{x}^{2} ( i , j ) + {d}_{y}^{2} ( i , j ) ) \times ( {d}_{x}^{2} ( r , c ) + {d}_{y}^{2} ( r , c ) )}} )}}$$

wherein the gradient vector of the first pixel (i, j) is [dₓ(i,j),d_{y}(i,j)] and the gradient vector of the second pixel (r, c) is [dₓ(r,c),d_{y}(r,c)]; and
Sc3: computing a turning radius (R):

R=v²×sin Q.

Furthermore, the step S4 comprises:

Sd1: computing a mean and a variance of turning radii (R) of all pixels; and
Sd2: determining a threshold (T) as: T=M+k×D, wherein k generally ranges from 0 to 3.

Furthermore, in the step S5: marking a pixel with a turning radius (R) which is greater than the threshold (T) and maximum in surrounding forty-eight neighborhoods as a corner.

Advantages of the turning radius-based corner detection algorithm of the invention are as follows: by virtue of the solution, the present invention can locate corners in an image accurately and restrain fake corners resulting from noises and textures, and it also can simplify the computation of the threshold and raise the computation efficiency, by which automatic detection is realized and effect of corner detection is improved. The invention is applicable to 3D reproduction, visual locating and measurement, etc.

### BRIEF DESCRIPTION OF DRAWINGS

FIG. 1 is a flow chart of the turning radius-based corner detection algorithm of the invention.

FIG. 2 shows the principle model for computation of the turning radius of the invention.

FIG. 3 is an original image without noise for comparison in the invention.

FIG. 4 shows information of corners by processing the original image without noise with Harris algorithm.

FIG. 5 shows information of corners by processing the original image without noise with the algorithm of the invention.

FIG. 6 is an image with salt-and-pepper noise for comparison in the invention.

FIG. 7 shows information of corners by processing the image with salt-and-pepper noise with Harris algorithm.

FIG. 8 shows information of corners by processing the image with salt-and-pepper noise with the method of the invention.

### DETAILED DESCRIPTION OF THE PREFERRED EMBODIMENTS

Embodiments will be described in detail in connection with drawings hereinafter, wherein the drawings are only for reference and demonstration rather than any limit on the protection scope of the invention.

As shown in FIG. 1, the invention discloses a turning radius-based corner detection algorithm, where an input image is saved as a matrix A of grayscale, each element A (i, j) in the matrix A stores the grayscale of the pixel in line i, column j.

The invention relates to a turning radius-based corner detection algorithm, comprising:

S1: removing noise by Gaussian filtering and computing a gradient value of each pixel of an original image; in particular, comprising:

Sa1: carrying out transverse and longitudinal Gaussian smoothing on the original image by using one-dimensional Gaussian operator and getting a smoothed image a, wherein the one-dimensional Gaussian operator is:

$$g ( x , σ ) = {e}^{- \frac{{x}^{2}}{2 {σ}^{2}}} ;$$

and
Sa2: carrying out transverse and longitudinal filtering on the smoothed image by using a partial derivative of two-dimensional Gaussian operator and getting a gradient of the image, wherein the two-dimensional Gaussian operator is

$$g ( x , y , σ ) = {e}^{- \frac{( {x}^{2} + {y}^{2} )}{2 {σ}^{2}}} ,$$

the transverse filtering formula is

$$\frac{\partial g ( x , y , σ )}{\partial x} ,$$

and the longitudinal filtering formula is

$$\frac{\partial g ( x , y , σ )}{\partial y} ;$$

S2: locating a neighboring pixel with closest grayscale to the pixel within given neighborhoods therearound; particularly, for any pixel (i, j) in the image a, selecting a pixel whose grayscale is closest to the pixel among four neighborhood pixels (i−1,j−1) (i−1,j) (i−1,j+1) (i,j−1) thereof as a closest neighboring pixel (r, c), wherein the pixel is named a first pixel (i, j) and the closest neighboring pixel is named a second pixel (r, c).

S3: computing a turning radius R between the pixel (the first pixel) (i, j) and the closest neighboring pixel (the second pixel) thereof; in particular, comprising:

Sc1: getting a turning velocity (v): dividing the grayscale difference a (i, j)−a(r, c) between the first pixel (i, j) and the second pixel (r, c) by a coordinate distance between the first and second pixels, and the formula is:

$$v = \frac{a ( i , j ) - a ( r , c )}{\sqrt{{( i - r )}^{2} + {( j - c )}^{2}}} ;$$

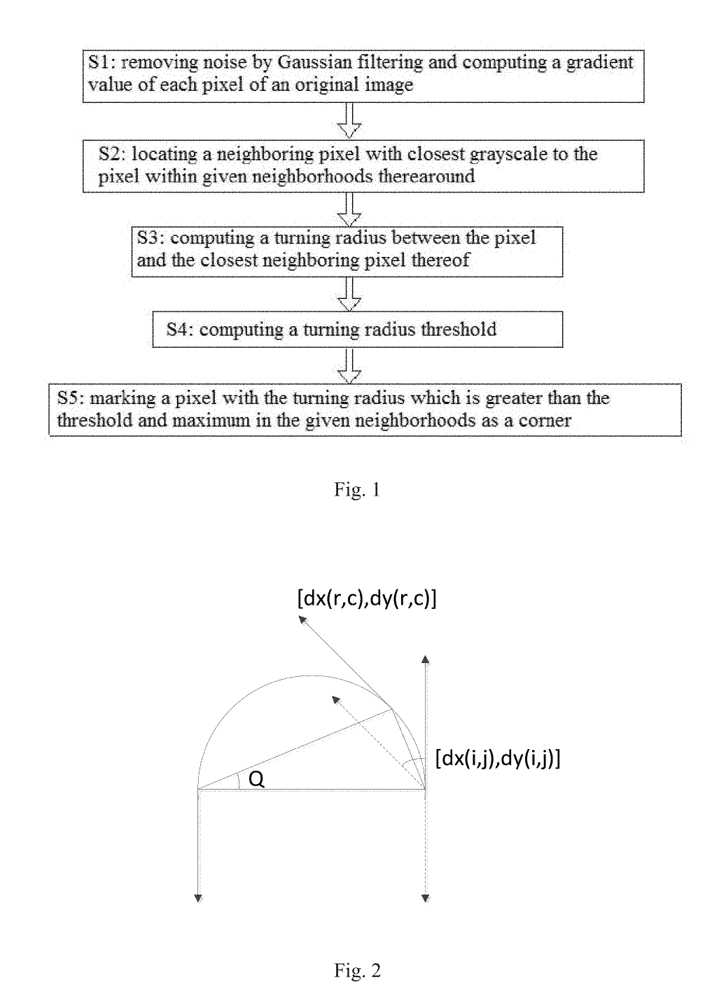

Sc2: computing sine (sin Q) of the turning angel: as shown in FIG. 2, the gradient vector of the first pixel (i, j) is [dₓ(i,j),d_{y}(i,j)] and the gradient vector of the second pixel (r, c) is [dₓ(r, c),d_{y}(r,c)] and an angle between gradient vectors of the first pixel (i, j) and the second pixel (r, c) is a turning angel between the first and second pixels, where sine of the turning angel sin Q is computed by the formula:

$$sin Q = \sqrt{\frac{1}{2 \times ( 1 - \frac{{d}_{x} ( i , j ) \times {d}_{x} ( r , c ) + {d}_{y } ( i , j ) \times {d}_{y} ( r , c )}{\sqrt{( {d}_{x}^{2} ( i , j ) + {d}_{y}^{2} ( i , j ) ) \times ( {d}_{x}^{2} ( r , c ) + {d}_{y}^{2} ( r , c ) )}} )}} ,$$

and
Sc3: computing a turning radius (R): computing the turning radius R according to the formula

$$R = \frac{{v}^{2}}{g tan θ} sin Q ,$$

wherein g is gravity acceleration, θ is a turning gradient, both of which can be omitted here, so the formula for the turning radius is:

R=v²×sin Q.

S4: computing a turning radius threshold; which further comprises:

Sd1: computing a mean (M) and a variance (D) of all turning radii (R) of all pixels; and
Sd2: determining a threshold (T) as: T=M+k×D, wherein k generally ranges from 0 to 3.

S5: marking a pixel with a turning radius (R) which is greater than the threshold (T) and maximum within surrounding forty-eight neighborhoods as a corner.

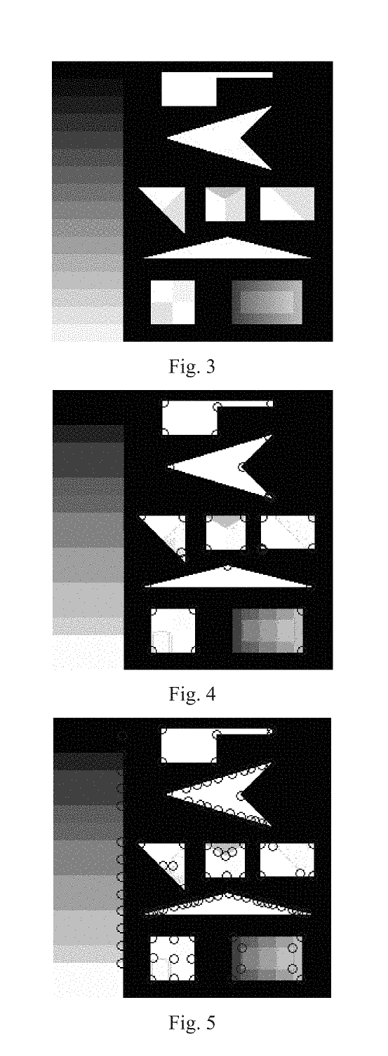

So as to demonstrate the effect of the turning radius-based corner detection algorithm of the invention, Harris algorithm and the turning radius-based corner detection algorithm of the present invention are respectively applied on the original image without noise shown in FIG. 3, whereby graphs of corners' information shown in FIGS. 4 and 5 are obtained. It is can be seen by comparing FIG. 4 with FIG. 5 that the detection accuracy of corners is greatly promoted by the corner detection algorithm of the present invention over Harris algorithm.

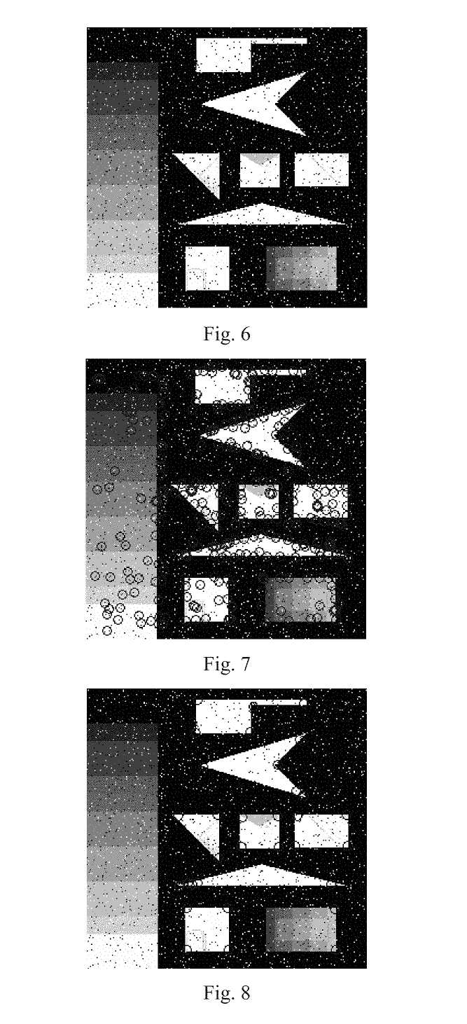

So as to further demonstrate the effect of the turning radius-based corner detection algorithm of the invention, another original image shown in FIG. 6 is formed by adding salt-and-pepper noise to the original image without noise shown in FIG. 3, and Harris algorithm and the turning radius-based corner detection algorithm of the present invention are respectively applied to process the image shown in FIG. 6 and whereby graphs of corners' information shown in FIGS. 7 and 8 are obtained. It is can be seen by comparing FIG. 7 with FIG. 8 that the anti-noise ability of corner detection is greatly promoted by the corner detection algorithm of the present invention over Harris algorithm even under the distraction of noise.

The foregoing descriptions are only preferred embodiments of the present invention rather than any limit on thereon in any form. One skilled in the art can carry out the invention along the description above and drawings. It should be noted that a number of improvements and modifications may also be made by the skilled in the art without departing from the principle of the present invention; these improvements and modifications are also encompassed within the scope of protection of the present invention.

1. A turning radius-based corner detection algorithm, characterized by comprising following steps:
S1: removing noise by Gaussian filtering and computing a gradient value of each pixel of an original image;
S2: locating a neighboring pixel with closest grayscale to the pixel within given neighborhoods therearound;
S3: computing a turning radius between the pixel and the closest neighboring pixel thereof;
S4: computing a turning radius threshold; and
S5: marking a pixel with the turning radius which is greater than the threshold and maximum in the given neighborhoods as a corner.

2. The turning radius-based corner detection algorithm according to claim 1, wherein the step S1 further comprises:
Sa1: carrying out transverse and longitudinal Gaussian smoothing on the original image by using one-dimensional Gaussian operator and getting a smoothed image (a); and
Sa2: carrying out transverse and longitudinal filtering on the smoothed image by using a partial derivative of two-dimensional Gaussian operator and getting a gradient of the image.

3. The turning radius-based corner detection algorithm according to claim 1, wherein in the step S2, for any pixel in the image (a), selecting a pixel whose grayscale is closest to the pixel from four neighboring pixels thereof as a closest neighboring pixel, wherein the pixel is named a first pixel (i, j) and the closest neighboring pixel is named a second pixel (r, c).

4. The turning radius-based corner detection algorithm according to claim 3, wherein the step S3 further comprises:
Sc1: dividing the grayscale difference a (i, j)−a (r, c) between the first pixel (i, j) and the second pixel (r, c) by a coordinate distance between the first and second pixels and getting a turning velocity (v) therebetween:
$$v = \frac{a ( i , j ) - a ( r , c )}{\sqrt{{( i - r )}^{2} + {( j - c )}^{2}}} ;$$
Sc2: taking an angle between gradient vectors of the first pixel (i, j) and the second pixel (r,c) as a turning angel between the first and second pixels, whose sine (sin Q) is:
$$sin Q = \sqrt{\frac{1}{2 \times ( 1 - \frac{{d}_{x} ( i , j ) \times {d}_{x} ( r , c ) + {d}_{y } ( i , j ) \times {d}_{y} ( r , c )}{\sqrt{( {d}_{x}^{2} ( i , j ) + {d}_{y}^{2} ( i , j ) ) \times ( {d}_{x}^{2} ( r , c ) + {d}_{y}^{2} ( r , c ) )}} )}}$$
wherein the gradient vector of the first pixel (i, j) is [dₓ(i,j),d_{y}(i,j)] and the gradient vector of the second pixel (r, c) is [dₓ(r,c),d_{y}(r,c)], and
Sc3: computing a turning radius (R):
R=v²×sin Q.

5. The turning radius-based corner detection algorithm according to claim 4, wherein the step S4 further comprises:
Sd1: computing a mean and a variance of turning radii (R) of all pixels; and
Sd2: determining a threshold (T) as: T=M+k×D, wherein k generally ranges from 0 to 3.

6. The turning radius-based corner detection algorithm according to claim 5, wherein in the step S5: marking a pixel with a turning radius (R) which is greater than the threshold (T) and maximum in surrounding forty-eight neighborhoods as a corner.

7. The turning radius-based corner detection algorithm according to claim 2, wherein in the step S2, for any pixel in the image (a), selecting a pixel whose grayscale is closest to the pixel from four neighboring pixels thereof as a closest neighboring pixel, wherein the pixel is named a first pixel (i, j) and the closest neighboring pixel is named a second pixel (r, c).

8. The turning radius-based corner detection algorithm according to claim 7, wherein the step S3 further comprises:
Sc1: dividing the grayscale difference a (i, j)−a (r, c) between the first pixel (i, j) and the second pixel (r, c) by a coordinate distance between the first and second pixels and getting a turning velocity (v) therebetween:
$$v = \frac{a ( i , j ) - a ( r , c )}{\sqrt{{( i - r )}^{2} + {( j - c )}^{2}}} ;$$
Sc2: taking an angle between gradient vectors of the first pixel (i, j) and the second pixel (r,c) as a turning angel between the first and second pixels, whose sine (sin Q) is:
$$sin Q = \sqrt{\frac{1}{2 \times ( 1 - \frac{{d}_{x} ( i , j ) \times {d}_{x} ( r , c ) + {d}_{y } ( i , j ) \times {d}_{y} ( r , c )}{\sqrt{( {d}_{x}^{2} ( i , j ) + {d}_{y}^{2} ( i , j ) ) \times ( {d}_{x}^{2} ( r , c ) + {d}_{y}^{2} ( r , c ) )}} )}}$$
wherein the gradient vector of the first pixel (i, j) is [dₓ(i,j),d_{y}(i,j)] and the gradient vector of the second pixel (r, c) is [d_{y}(r,c),d_{y}(r,c)]; and
Sc3: computing a turning radius (R):
R=v²×sin Q.

9. The turning radius-based corner detection algorithm according to claim 8, wherein the step S4 further comprises:
Sd1: computing a mean and a variance of turning radii (R) of all pixels; and
Sd2: determining a threshold (T) as: T=M+k×D, wherein k generally ranges from 0 to 3.

10. The turning radius-based corner detection algorithm according to claim 9, wherein in the step S5: marking a pixel with a turning radius (R) which is greater than the threshold (T) and maximum in surrounding forty-eight neighborhoods as a corner.
